(19) United States
(12) Patent Application Publication
(10) Pub. No.: US 2014/0278961 A1
(43) Pub. Date: Sep. 18, 2014

(54) INFORMATION PROCESSING DEVICE AND PROGRAM

(71) Applicant: SONY CORPORATION, Tokyo (JP)

(72) Inventor: Hiroaki Kitano, Saitama (JP)

(21) Appl. No.: 14/349,517

(22) PCT Filed: Oct. 24, 2012
(86) PCT No.: PCT/JP2012/077445

§ 371 Date: Apr. 3, 2014

(30) Foreign Application Priority Data
Dec. 2, 2011 (JP) 2011-265121

(51) Int. Cl. G06Q 30/02

(52) U.S. Cl. CPC G06Q 30/0251
USPC 705/14.49

(57) ABSTRACT

Provided is an information processing device including a content acquiring unit configured to acquire content, a first display unit configured to display the content, a promotion information acquiring unit configured to acquire promotion information related to the content, and a second display unit configured to display the promotion information.

### TECHNICAL FIELD

The present disclosure relates to an information processing device and a program, and more particularly, to an information processing device and a program which are capable of controlling a plurality of displays.

### BACKGROUND ART

In recent years, information processing devices including a plurality of displays have become increasingly common. For example, there are portable information processing devices in which displays are arranged on inner sides of a foldable housing, and thus an amount of information that can be displayed is increased while securing portability of a device. Patent Literature 1 discloses a technique of causing displays of two display units to collaborate with each other in such an information processing device.

### CITATION LIST

### Patent Literature

Patent Literature 1: JP2011-053790A

### SUMMARY OF INVENTION

### Technical Problem

However, in the above-mentioned technique, there is room for further improvement in the utilization of a plurality of displays of the information processing device.

In this regard, the present disclosure proposes an information processing device and a program, which are novel and improved and capable of more effectively utilizing a display by a plurality of displays.

### Solution to Problem

According to the present disclosure, there is provided an information processing device including a content acquiring unit configured to acquire content, a first display unit configured to display the content, a promotion information acquiring unit configured to acquire promotion information related to the content, and a second display unit configured to display the promotion information.

According to the present disclosure, there is provided a program causing a computer to implement a function of acquiring content, a function of causing the content to be displayed on a first display unit, a function of acquiring promotion information related to the content, and a function of causing the promotion information to be displayed on a second display unit.

Here, in the present disclosure, for example, promotion information means information used to promote something such as advertisement information, a cover image, or label information. As will be described later, for example, the advertisement information is used to promote products or the like. The cover image is used to promote the user himself or herself. The label information is used to promote content.

According to the present disclosure, promotion information related to content is acquired, and displayed on a second display unit different from a first display unit on which content is displayed.

### Advantageous Effects of Invention

As described above, according to the present disclosure, it is possible to more effectively utilize a display by a plurality of displays.

### BRIEF DESCRIPTION OF DRAWINGS

FIG. 1 is a block diagram illustrating a functional configuration of an information processing device according to a first embodiment of the present disclosure.

FIG. 2 is a diagram illustrating a first exemplary display of the information processing device according to the first embodiment of the present disclosure.

FIG. 3 is a diagram illustrating a second exemplary display of the information processing device according to the first embodiment of the present disclosure.

FIG. 4 is a diagram illustrating exemplary meta information in the first embodiment of the present disclosure.

FIG. 5 is a diagram illustrating an exemplary processing flow of the information processing device according to the first embodiment of the present disclosure.

FIG. 6 is a diagram illustrating a first exemplary display of an information processing device according to a second embodiment of the present disclosure.

FIG. 7 is a diagram illustrating a first exemplary display of an information processing device according to a second embodiment of the present disclosure.

FIG. 8 is a block diagram illustrating a functional configuration of an information processing device according to a third embodiment of the present disclosure.

FIG. 9 is a diagram illustrating an exemplary display of the information processing device according to the third embodiment of the present disclosure.

FIG. 10 is a block diagram for describing a hardware configuration of an information processing device.

### DESCRIPTION OF EMBODIMENTS

Hereinafter, preferred embodiments of the present disclosure will be described in detail with reference to the appended drawings. Note that, in this specification and the drawings, elements that have substantially the same function and structure are denoted with the same reference signs, and repeated explanation is omitted.

A description will proceed in the following order.

1. First embodiment (example of advertisement information)

2. Second embodiment (example of advertisement information or cover image)

3. Third embodiment (example of label information)

4. Supplement

### 1. First Embodiment

First, a first embodiment of the present disclosure will be described with reference to FIGS. 1 to 5. FIG. 1 is a block diagram illustrating a functional configuration of an information processing device according to a first embodiment of the present disclosure. FIG. 2 is a diagram illustrating a first exemplary display of the information processing device according to the first embodiment of the present disclosure. FIG. 3 is a diagram illustrating a second exemplary display of the information processing device according to the first embodiment of the present disclosure. FIG. 4 is a diagram illustrating exemplary meta information in the first embodiment of the present disclosure. FIG. 5 is a diagram illustrating an exemplary processing flow of the information processing device according to the first embodiment of the present disclosure.

(Functional Configuration)

Referring to FIG. 1, an information processing device 100 according to the first embodiment of the present disclosure includes a content acquiring unit 110, a first display unit 120, an information acquiring unit 130, and a second display unit 140. For example, the information processing device 100 may be a terminal device such as a personal computer (PC) of a tablet type, a notebook type, or a desktop type, a mobile telephone, a smartphone, a personal digital assistant (PDA), or various kinds of media players.

For example, the content acquiring unit 110 is implemented by a central processing unit (CPU), a random access memory (RAM), a read only memory (ROM), and the like, and acquires content. In the present embodiment, content refers to an electronic book. Thus, the content acquiring unit 110 acquires data of an electronic book, for example, from a server via a network. As will be described later, meta information is attached to content, and the content acquiring unit 110 may acquire the meta information together with the content. Further, in the present disclosure, content is not limited to an electronic book, and may be any other content that can be displayed on a display such as video content. Further, in the present embodiment, a moving image may be embedded in an electronic book. The first display unit 120 is a display that displays content acquired by the content acquiring unit 110.

For example, the information acquiring unit 130 is implemented by a CPU, a RAM, a ROM, and the like, and acquires advertisement information related to the content acquired by the content acquiring unit 110. The advertisement information is information used to promote a product or the like, and is an example of the promotion information in the present technology. For example, the information acquiring unit 130 acquires the advertisement information according to meta information acquired together with the content by the content acquiring unit 110. As will be described later, for example, the meta information may be information designating an acquisition source of the advertisement information. Further, the information acquiring unit 130 may analyze the details of the content acquired by the content acquiring unit 110 and search for the advertisement information based on the details of the content. Further, the advertisement information is acquired from the designated acquisition source according to the meta information, but whether or not search is performed may be designated based on the details of the content. The second display unit 140 is a display that displays the advertisement information acquired by the information acquiring unit 130.

(Exemplary Display)

Referring to FIGS. 2 and 3, the information processing device 100 includes a foldable housing, and displays are arranged on inner sides of the housing. One of the displays is used as the first display unit 120, and the other is used as the second display unit 140. In other words, both of the first display unit 120 and the second display unit 140 are arranged to face the user of the information processing device 100. The following description will proceed with two exemplary displays that are different in a display of the second display unit 140.

In the example of FIG. 2, content 1201 is displayed on the first display unit 120. As described above, in the present embodiment, the content is an electronic book. Thus, the content 1201 is text of an electronic book. Meanwhile, designated advertisement information 1401 is displayed on the second display unit 140.

Here, for example, the designated advertisement information 1401 is acquired as the information acquiring unit 130 acquires the advertisement information from the acquisition source designated by the meta information acquired together with the content by the content acquiring unit 110. In the above example, the acquisition source designated by the meta information is, for example, a server of a publishing company that publishes electronic books. In this case, the information acquiring unit 130 accesses the server of the publishing company via a network, and acquires the designated advertisement information 1401.

Further, it is possible to attach the designated advertisement information 1401 to the content as the meta information, but as described above, the information acquiring unit 130 can access the acquisition source, acquire, for example, latest advertisement information, and display the acquired latest advertisement information as the designated advertisement information 1401. This configuration is effective, for example, when the content 1201 of the electronic book is downloaded, then stored in a storage of the information processing device 100, and read after the passage of time, that is, when the content need not necessarily be downloaded in real time.

Further, when the designated advertisement information 1401 is acquired, for example, an attribute such as the user's location, the user's age or sex, or the like may be considered. For example, when the information processing device 100 includes a position sensor such as a Global Positioning System (GPS) receiver, the information acquiring unit 130 may select an acquisition source of a region corresponding to the user's position from among acquisition sources of regions designated by the meta information and acquire the advertisement information from the selected acquisition source. Further, when the user's attribute information is registered in the information processing device 100, the information acquiring unit 130 may select an acquisition source of an attribute corresponding to the user's attribute from among acquisition sources of attributes designated by the meta information with reference to the attribute information and acquire the advertisement information from the selected acquisition source.

In the example of FIG. 3, the content 1201 is displayed on the first display unit 120, similarly to the example of FIG. 2. Meanwhile, free advertisement information 1403 is displayed on the second display unit 140. In the example of FIG. 3, the free advertisement information 1403 is advertisement information related to the word “patent” included in the text of the electronic book displayed as the content 1201.

Here, for example, the free advertisement information 1403 is acquired as the information acquiring unit 130 analyzes the details of the content (here, the text of the electronic book), and searches for advertisement information present on a network using the keyword “patent” extracted as a result of analysis. Advertisement information of a search target may be limited to, for example, advertisement information registered in a certain server.

(Summary)

As in the above example, when the content and the advertisement information are displayed on the display of the information processing device, for example, when both the content and the advertisement information are displayed on the same display, for example, the advertisement information cuts into the margin of the content. In this case, the advertisement information may conceal the content. Further, there are cases in which it is difficult to display a sufficient amount of information as the advertisement information due to a space limitation. Thus, there are cases in which the effect of the advertisement information is not sufficient.

In this regard, in the information processing device 100, one of two displays is used as the first display unit 120 to display the content 1201, and the other is used as the second display unit 140 to display the designated advertisement information 1401 or the free advertisement information 1403. As the display unit displaying content is separated from the display unit displaying an advertisement, the content is easily viewed, and it is possible to increase an amount of information displayed as the advertisement information. Thus, the information processing device 100 can achieve both comfort for the user using the content and an advertising effect.

(Exemplary Display Control)

FIG. 4 illustrates exemplary meta information 1203 attached to the content 1201 when the designated advertisement information 1401 and the free advertisement information 1403 are alternately displayed on the second display unit 140 of the information processing device 100 as in the examples of FIGS. 2 and 3.

As described above, the information acquiring unit 130 of the information processing device 100 acquires the advertisement information according to the meta information acquired together with the content by the content acquiring unit 110. In the example illustrated in FIG. 4, the meta information 1203 is set in units of pages of the electronic book serving as the content. More specifically, first meta information 1203a designating an acquisition source from which the designated advertisement information 1401 is acquired is attached to 1st to 9th pages, . . . , and 20th to 29th pages of the electronic book, and second meta information 1203b allowing a display of the free advertisement information 1403 is attached to 10th to 19th pages, . . . , and 30th to 40th pages.

When the 1st to 9th pages, . . . , or the 20th to 29th pages of the electronic book are displayed as the content 1201, the information acquiring unit 130 acquires the designated advertisement information 1401 from the acquisition source designated by the first meta information 1203a according to the meta information 1203. Further, when the 10th to 19th pages, . . . , or the 30th to 40th pages of the electronic book are displayed as the content 1201, the information acquiring unit 130 searches for the free advertisement information 1403 according to the second meta information 1203b.

As described above, the meta information 1203 may include not only information representing an acquisition destination for acquiring the designated advertisement information 1401 but also information representing how the information acquiring unit 130 acquires the advertisement information. Thus, for example, the publishing company providing the electronic book may cause an advertisement for its own company to be displayed in pages to which the first meta information 1203a is set as the designated advertisement information 1401, cause the free advertisement information 1403, that is, advertisement information of other service providers, to be displayed in pages to which the second meta information 1203b is set, and thus receive an advertising fee from the company for which the advertisement information is displayed (for example, like a commercial in television broadcasting).

FIG. 5 is a flowchart illustrating an exemplary process of the information acquiring unit 130 when such advertisement information is displayed.

First, the information acquiring unit 130 acquires the meta information 1203 acquired together with the content 1201 by the content acquiring unit 110 (step S101). Here, the information acquiring unit 130 determines whether the acquisition source of the advertisement information has been designated by the meta information 1203 (step S103).

When the acquisition source of the advertisement information has been designated by the meta information 1203, the information acquiring unit 130 acquires the advertisement information from the designated acquisition source (step S105), and the advertisement information is displayed (step S109). In this case, the designated advertisement information 1401 is displayed on the second display unit 140.

However, when the acquisition source of the advertisement information has not been designated by the meta information 1203, the information acquiring unit 130 searches for the advertisement information based on the details of the content 1201 (step S107), and the advertisement information acquired through the search is displayed (step S109). In this case, the free advertisement information 1403 is displayed on the second display unit 140.

(Supplement)

The first embodiment of the present disclosure has been described above in connection with the example in which, in the information processing device in which the two displays are arranged to face the user, one display is used as the first display unit, and the other display is used as the second display unit.

Here, the advertisement information displayed through the second display unit is acquired by the information acquiring unit. For example, the second display unit acquires the advertisement information from the acquisition source designated by the meta information attached to the content or acquires the advertisement information by searching for the advertisement information based on the details of the content.

In the above example, it is determined whether the second display unit acquires the advertisement information from the acquisition source or searches for the advertisement information based on the details of the content according to the meta information attached to the content. However, the present technology is not limited to this example, and for example, either the designated advertisement information or the free advertisement information may be displayed over the entire content. When the free advertisement information is displayed over the entire content, the meta information related to the advertisement information may not be attached to the content.

Further, for example, the advertisement information serving as the search target of the free advertisement information may be limited to advertisement information registered in a certain server. In this case, as described above, the publishing company may be involved in registration of the advertisement information to the server and receive the advertising fee from service providers that register the advertisement information. In this case, the manufacturer may return the advertising fee to the user as the price of the information processing device.

### 2. Second Embodiment

Next, a second embodiment of the present disclosure will be described with reference to FIGS. 6 and 7. FIG. 6 is a diagram illustrating a first exemplary display of an information processing device according to a second embodiment of the present disclosure. FIG. 7 is a diagram illustrating a first exemplary display of an information processing device according to a second embodiment of the present disclosure.

The second embodiment is different from the first embodiment in that one of the displays of the information processing device is arranged to face the user, and the other is arranged to face another user located nearby. The second embodiment is the same in the other point as the first embodiment, and thus a detailed description thereof is omitted.

(Exemplary Display)

Referring to FIGS. 6 and 7, an information processing device 200 includes a tablet type housing, and displays are arranged on both sides. Of the displays, a display arranged on the side facing the user is used as a first display unit 120, and a display arranged on the back thereof is used as a second display unit 140. The following description will proceed with two exemplary displays that are different in a display of the second display unit 140.

In the example of FIG. 6, content 1201 is displayed on the first display unit 120. In the present embodiment, similarly to the first embodiment, the content is an electronic book. Thus, the content 1201 is text of an electronic book. Meanwhile, designated advertisement information 1401 is displayed on the second display unit 140.

Here, the designated advertisement information 1401 is advertisement information acquired in the same manner as in the first embodiment. In the present embodiment, since the second display unit 140 is arranged to face the user located nearby, for example, a marker such as a 2D code 1405 used to access a web site of a service provider may be displayed on the designated advertisement information 1401.

In this case, the 2D code 1405 may include not only information of an access destination such as a site but also information specifying the user displaying the advertisement information so that the user displaying the advertisement information from which a site or the like is accessed can be identified. Thus, for example, a point of a point service may be given to the user who accesses the site and the user who displays the advertisement information serving as the access source.

Further, the free advertisement information 1403 may similarly be displayed on the second display unit 140.

In the example of FIG. 7, the content 1201 is displayed on the first display unit 120, similarly to the example of FIG. 6. As illustrated in FIG. 7, the content 1201 of the electronic book may include an image such as a photograph as well as text. Meanwhile, a cover image 1407 of the electronic book is displayed on the second display unit 140. The cover image 1407 is information used to attract another user located nearby to the electronic book read as the content 1201 by the user and promote the user himself or herself, and is an example of the promotion information in the present technology. Further, the cover image 1407 can be the advertisement information in the sense that another user located nearby recognizes that the electronic book is being read, and so the sale of the electronic book is promoted.

Here, for example, the cover image 1407 may be included in the meta information acquired together with the content 1201 by the content acquiring unit 110 as image data. The cover image 1407 may be acquired from the acquisition source designated by the meta information. Further, the cover image 1407 may be a first page of the content 1201 and may be continuously displayed even after the content 1201 proceeds to another page.

(Supplement)

The second embodiment of the present disclosure has been described above in connection with the example in which, in the information processing device in which the two displays are arranged to face the user side and the side of another user located, one display is used as the first display unit, and the other display is used as the second display unit.

Here, information display on the second display unit may be the same advertisement information as in the first embodiment. In the present embodiment, since the information displayed on the second display unit is displayed toward another user located nearby, a target for whom the advertisement information is displayed is different from that in the first embodiment.

Further, a cover image of content that is an electronic book may be displayed on the second display unit. In this case, the user can casually attract another user located nearby to the electronic book he or she is reading (for example, when a businessman reads an economic magazine). This serves to give the user a similar sense as in print media with which he or she is familiar.

(Other Examples)

In addition to the above examples, various embodiments can be made in the information processing device in which the second display unit is arranged toward the user located nearby. In the following example, the first display unit is referred to as a main display unit, and the second display unit is referred to as a back display unit.

For example, the main display unit and the back display unit may display an image in collaboration with each other. For example, in the information processing device, the main display unit may display text in a language (for example, Japanese) used by the user, and the back display unit may display text in another language (for example, English) corresponding to the corresponding text. In this case, a display corresponding to an operation performed by a touch panel or a mouse in the main display unit may be performed in the back display unit. In the above example, when a certain portion of the Japanese text of the main display unit is selected by an operation performed by the user through the touch panel or the like, a portion corresponding to the text selected in the main display unit in the English text of the back display unit may be highlighted and displayed.

Further, as an example similar to a display of the 2D code, an image having no marker recognizable by image recognition may be displayed on the back display unit. When this image is recognized by the information processing device of another user, information may be transmitted to a certain server so that the user recognizing the image and the user displaying the image can be specified. In this case, both another user and the user may be given a point of a point service or the like as described above. In this case, even when the marker or the image is not actually recognized by another information processing device, for example, it may be determined whether the image displayed on the back display unit is recognizable from the outside through the GPS, a camera, a touch sensor, or an open/closed state when a housing is foldable, and when the image is in the recognizable state, the user may be given a point.

In the example in which the user is specified by recognition of a marker or an image, a marker or an image may be set as a collection target, and the user who has recognized a certain number of markers or images through the information processing device may be given a point of a point service or the like. In this case, for example, an event such as a stamp rally in which other moving users are set as a collection target can be held.

Further, a point may be given using position information of the user as a condition. For example, a condition in which a point is given to the user who has collected a certain number of markers or images displayed on the information processing devices of the other users at a certain time and a certain place may be set. In this case, for example, as a condition of “at Ginza on Sunday afternoon” is set, a number of users gather at a target time and place, and thus an additional advertising effect can be obtained by the information processing devices of the users in which the same image is displayed on the back display unit.

### 3. Third Embodiment

Next, a third embodiment of the present disclosure will be described with reference to FIGS. 8 and 9. FIG. 8 is a block diagram illustrating a functional configuration of an information processing device according to a third embodiment of the present disclosure. FIG. 9 is a diagram illustrating an exemplary display of the information processing device according to the third embodiment of the present disclosure.

(Functional Configuration)

Referring to FIG. 8, an information processing device 300 according to the third embodiment of the present disclosure includes a content acquiring unit 110, a first display unit 120, a back label acquiring unit 330, and a second display unit 340. The information processing device 300 is similar to the information processing device 100 according to the first embodiment, but different in the functional configuration of the back label acquiring unit 330 and the second display unit 340.

For example, the back label acquiring unit 330 is implemented by a CPU, a RAM, a ROM, and the like, and sets back label information based on the content acquired by the content acquiring unit 110. The back label information is information displayed as a label identifying content and is an example of the promotion information in the present technology. For example, the back label acquiring unit 330 acquires the back label information included in the meta information acquired together with the content by the content acquiring unit 110. Further, the back label acquiring unit 330 may extract a specific portion of the content as the back label information. The second display unit 340 is a display that displays the back label information acquired by the back label acquiring unit 330.

(Exemplary Display)

Referring to FIG. 9, the information processing device 300 includes a tablet type housing, and displays are arranged on both sides. Of the displays, a display arranged on the side facing the user is used as a first display unit 120, and a display arranged on the back thereof is used as a second display unit 340. Unlike the information processing device 200 according to the second embodiment, the second display unit 340 may be smaller than the first display unit 120.

In the example of FIG. 9, customer data 3201 is displayed on the first display unit 120 as content. In the present embodiment, the content is customer data. The information processing device 300 may be a terminal device that is allocated to a certain customer during a certain period of time and used to display and collect customer data of the customer. Meanwhile, back label information 3401 is displayed on the second display unit 340.

Here, the back label information 3401 is acquired by the back label acquiring unit 330. In the example illustrated in FIG. 9, a portion of a customer name such as “Mr. ∘∘ ∘∘” of the customer data 3201 serving as the content is displayed as the back label information 3401. Through the back label information 3401, for example, the user can identify a customer that is a target of the customer data 3201 displayed on the information processing device 300.

Here, the second display unit 340 may employ a system that is smaller in power consumption than the first display unit 120 such as electronic paper. In this case, even when there is no display by the first display unit 120, that is, even when the information processing device 300 is not used, the back label information 3401 can be continuously displayed on the second display unit 340. Thus, when starting to use the information processing device 300, the user can identify a customer who is assigned the information processing device 300 even though there is no display by the first display unit 120.

Similarly to the above example, for example, when the content displayed on the first display unit is the electronic book, information serving as the spine of the electronic book may be displayed on the second display unit. Thus, for example, when a plurality of electronic books are held in a plurality of reader terminals, it is possible to easily identify which terminal holds what electronic book. Further, information displayed on the second display unit may not necessarily be information that corresponds to content in a one-to-one manner such as information representing a genre of an electronic book held in the reader terminal

### 4. Supplement

### (Hardware Configuration)

A hardware configuration of the information processing apparatus 900 that can realize the information processing apparatus according to the embodiment of the present disclosure will be described with reference to FIG. 10. FIG. 10 is a block diagram for explaining a hardware configuration of the information processing device.

The information processing apparatus 900 includes a CPU 901, ROM 903, and RAM 905. Further, the information processing apparatus 900 may include a host bus 907, a bridge 909, an external bus 911, an interface 913, an input device 915, an output device 917, a storage device 919, a drive 921, a connection port 923, and a communication device 925.

The CPU 901 serves as an operation processor and a controller, and controls all or some operations in the information processing apparatus 900 in accordance with various programs recorded in the ROM 903, the RAM 905, the storage device 919 or a removable recording medium 927. The ROM 903 stores programs and operation parameters which are used by the CPU 901. The RAM 905 primarily stores program which are used in the execution of the CPU 901 and parameters which is appropriately modified in the execution. The CPU 901, ROM 903, and RAM 905 are connected to each other by the host bus 907 configured to include an internal bus such as a CPU bus. In addition, the host bus 907 is connected to the external bus 911 such as a PCI (Peripheral Component Interconnect/Interface) bus via the bridge 909.

The input device 915 may be a device which is operated by a user, such as a mouse, a keyboard, a touch panel, buttons, switches and a lever. The input device 915 may be, for example, a remote control unit using infrared light or other radio waves, or may be an external connection device 929 such as a portable phone operable in response to the operation of the information processing apparatus 900. Furthermore, the input device 915 includes an input control circuit which generates an input signal on the basis of the information which is input by a user and outputs the input signal to the CPU 901. By operating the input device 915, a user can input various types of data to the information processing apparatus 900 or issue instructions for causing the information processing apparatus 900 to perform a processing operation.

The output device 917 includes a device capable of visually or audibly notifying the user of acquired information. The output device 917 may include a display device such as LCD (Liquid Crystal Display), PDP (Plasma Display Panel), and organic EL (Electro-Luminescence) displays, an audio output device such as speaker and headphone, and a peripheral device such as printer. The output device 917 may output the results obtained from the process of the information processing apparatus 900 in a form of a video such as text or image, and an audio such as voice or sound.

The storage device 919 is a device for data storage which is configured as an example of a storage unit of the information processing apparatus 900. The storage device 919 includes, for example, a magnetic storage device such as HDD (Hard Disk Drive), a semiconductor storage device, an optical storage device, or a magneto-optical storage device. The storage device 919 stores programs to be executed by the CPU 901, various data, and data obtained from the outside.

The drive 921 is a reader/writer for the removable recording medium 927 such as a magnetic disk, an optical disk, a magneto-optical disk, or a semiconductor memory, and is embedded in the information processing apparatus 900 or attached externally thereto. The drive 921 reads information recorded in the removable recording medium 927 attached thereto, and outputs the read information to the RAM 905. Further, the drive 921 can write in the removable recording medium 927 attached thereto.

The connection port 923 is a port used to directly connect devices to the information processing apparatus 900. The connection port 923 may include a USB (Universal Serial Bus) port, an IEEE1394 port, and a SCSI (Small Computer System Interface) port. The connection port 923 may further include an RS-232C port, an optical audio terminal, an HDMI (High-Definition Multimedia Interface) port, and so on. The connection of the external connection device 929 to the connection port 923 makes it possible to exchange various data between the information processing apparatus 900 and the external connection device 929.

The communication device 925 is, for example, a communication interface including a communication device or the like for connection to a communication network 931. The communication device 925 may be, for example, a communication card for a wired or wireless LAN (Local Area Network), Bluetooth (registered trademark), WUSB (Wireless USB) or the like. In addition, the communication device 925 may be a router for optical communication, a router for ADSL (Asymmetric Digital Subscriber Line), a modem for various kinds of communications, or the like. The communication device 925 can transmit and receive signals to and from, for example, the Internet or other communication devices based on a predetermined protocol such as TCP/IP. In addition, the communication network 931 connected to the communication device 925 may be a network or the like connected in a wired or wireless manner, and may be, for example, the Internet, a home LAN, infrared communication, radio wave communication, satellite communication, or the like.

The foregoing thus illustrates an exemplary hardware configuration of the information processing apparatus 900. Each of the above components may be realized using general-purpose members, but may also be realized in hardware specialized in the function of each component. Such a configuration may also be modified as appropriate according to the technological level at the time of the implementation.

(Remarks)

The above description has been made in connection with the embodiment in which the information processing device is of a foldable type or a tablet type. However, as described above, the user terminal may be various devices that can provide content to the user and include a plurality of displays such as a PC of a notebook type, or a desktop type, a mobile telephone, a smartphone, a PDA, or various kinds of media players. The number of displays equipped in the information processing device is not limited to two and may be three or more. For example, the information processing device may include first and second displays arranged to face the user and a third display arranged to face another user located nearby. In this case, for example, content may be displayed on the first display, and promotion information may be displayed on both of the second and third displays. At this time, different kinds of promotion images may be displayed on the respective displays, for example, such that advertisement information is displayed on the second display, and a cover image of content is displayed on the third display. Further, the second and third displays may be selectively used, and promotion information may be displayed on one of the second and third displays.

The above description has been made in connection with an embodiment in which content is mainly electronic book content of a still image. However, as described above, content may be video content or the like. The embodiment of the present disclosure can be applied regardless of whether content, a still image, a moving image, or a combination thereof is used. For example, in the case of video content, free advertisement information may be searched for using an attribute or the details represented by meta information attached to content as a keyword.

The preferred embodiments of the present invention have been described above with reference to the accompanying drawings, whilst the present invention is not limited to the above examples, of course. A person skilled in the art may find various alterations and modifications within the scope of the appended claims, and it should be understood that they will naturally come under the technical scope of the present invention.

Additionally, the present technology may also be configured as below.
(1) An information processing device including:

a content acquiring unit configured to acquire content;

a first display unit configured to display the content;

a promotion information acquiring unit configured to acquire promotion information related to the content; and

a second display unit configured to display the promotion information.
(2) The information processing device according to (1),

wherein the content acquiring unit acquires meta information attached to the content, and

wherein the promotion information acquiring unit acquires the promotion information according to the meta information.
(3) The information processing device according to (2),

wherein the promotion information is advertisement information,

wherein the meta information includes first meta information designating an acquisition source of the advertisement information, and

wherein the promotion information acquiring unit acquires the advertisement information from the acquisition source according to the first meta information.
(4) The information processing device according to (2) or (3),

wherein the promotion information is the advertisement information,

wherein the meta information includes second meta information allowing a free search of the advertisement information, and

wherein the promotion information acquiring unit searches for the advertisement information based on details of the content according to the second meta information.
(5) The information processing device according to any one of (1) to (4),

wherein the first display unit and the second display unit are arranged to face a user of the information processing device.
(6) The information processing device according to any one of (1) to (4),

wherein the first display unit is arranged to face a user of the information processing device, and

wherein the second display unit is arranged to face another user near the user of the information processing device.
(7) The information processing device according to (6),

wherein the promotion information is information representing the content.
(8) The information processing device according to (7),

wherein the content is an electronic book, and

wherein the promotion information is a cover image of the electronic book.
(9) The information processing device according to (7),

wherein the content is customer data, and

wherein the promotion information is information identifying the customer.
(10) The information processing device according to any one of (1) to (9),

wherein the second display unit is a display unit of a system that is smaller in power consumption than the first display unit.
(11) A program causing a computer to implement:

a function of acquiring content;

a function of causing the content to be displayed on a first display unit;

a function of acquiring promotion information related to the content; and

a function of causing the promotion information to be displayed on a second display unit.
(12) The program according to (11),

wherein the function of acquiring the content further includes acquiring meta information attached to the content, and

wherein the function of acquiring the promotion information includes acquiring the promotion information according to the meta information.
(13) The program according to (12),

wherein the promotion information is advertisement information,

wherein the meta information includes first meta information designating an acquisition source of the advertisement information, and

wherein the function of acquiring the promotion information includes acquiring the advertisement information from the acquisition source according to the first meta information.
(14) The program according to (12) or (13),

wherein the promotion information is the advertisement information,

wherein the meta information includes second meta information allowing a free search of the advertisement information, and

wherein the function of acquiring the promotion information includes searching for the advertisement information based on details of the content according to the second meta information.

### REFERENCE SIGNS LIST

100, 200, 300 information processing device
110 content acquiring unit
120 first display unit
130 information acquiring unit
330 back label acquiring unit
140, 340 second display unit
1201 content
3201 customer data
1401 designated advertisement information
1403 free advertisement information
1405 2D code
1407 cover image
3401 back label information

1. An information processing device comprising:
a content acquiring unit configured to acquire content;
a first display unit configured to display the content;
a promotion information acquiring unit configured to acquire promotion information related to the content; and
a second display unit configured to display the promotion information.

2. The information processing device according to claim 1,
wherein the content acquiring unit acquires meta information attached to the content, and
wherein the promotion information acquiring unit acquires the promotion information according to the meta information.

3. The information processing device according to claim 2,
wherein the promotion information is advertisement information,
wherein the meta information includes first meta information designating an acquisition source of the advertisement information, and
wherein the promotion information acquiring unit acquires the advertisement information from the acquisition source according to the first meta information.

4. The information processing device according to claim 2,
wherein the promotion information is the advertisement information,
wherein the meta information includes second meta information allowing a free search of the advertisement information, and
wherein the promotion information acquiring unit searches for the advertisement information based on details of the content according to the second meta information.

5. The information processing device according to claim 1,
wherein the first display unit and the second display unit are arranged to face a user of the information processing device.

6. The information processing device according to claim 1,
wherein the first display unit is arranged to face a user of the information processing device, and
wherein the second display unit is arranged to face another user near the user of the information processing device.

7. The information processing device according to claim 6,
wherein the promotion information is information representing the content.

8. The information processing device according to claim 7,
wherein the content is an electronic book, and
wherein the promotion information is a cover image of the electronic book.

9. The information processing device according to claim 7,
wherein the content is customer data, and
wherein the promotion information is information identifying the customer.

10. The information processing device according to claim 1,
wherein the second display unit is a display unit of a system that is smaller in power consumption than the first display unit.

11. A program causing a computer to implement:
a function of acquiring content;
a function of causing the content to be displayed on a first display unit;
a function of acquiring promotion information related to the content; and
a function of causing the promotion information to be displayed on a second display unit.

12. The program according to claim 11,
wherein the function of acquiring the content further includes acquiring meta information attached to the content, and
wherein the function of acquiring the promotion information includes acquiring the promotion information according to the meta information.

13. The program according to claim 12,
wherein the promotion information is advertisement information,
wherein the meta information includes first meta information designating an acquisition source of the advertisement information, and
wherein the function of acquiring the promotion information includes acquiring the advertisement information from the acquisition source according to the first meta information.

14. The program according to claim 12,
wherein the promotion information is the advertisement information,
wherein the meta information includes second meta information allowing a free search of the advertisement information, and
wherein the function of acquiring the promotion information includes searching for the advertisement information based on details of the content according to the second meta information.
